(19) United States
(12) Patent Application Publication
(10) Pub. No.: US 2026/0243372 A1
(43) Pub. Date: Aug. 20, 2026

(54) SEALING MEMBER

(71) Applicant: Sumitomo Riko Company Limited, Aichi (JP)

(72) Inventors: Taishi Tsuchiya, Aichi (JP); Takahiro Morita, Aichi (JP); Ryo Hirai, Aichi (JP)

(73) Assignee: Sumitomo Riko Company Limited, Aichi (JP)

(21) Appl. No.: 19/640,455

(22) Filed: Apr. 7, 2026

Related U.S. Application Data
(63) Continuation of application No. PCT/JP2025/007773, filed on Mar. 4, 2025.

(30) Foreign Application Priority Data
Mar. 28, 2024 (JP) 2024-053262

(51) Int. Cl. F16L 5/10; C08K 3/22; C08K 3/36; C08K 5/14; C08K 5/20; C08K 5/3447

(52) U.S. Cl. CPC F16L 5/10; C08K 3/22; C08K 3/36; C08K 5/14; C08K 5/20; C08K 5/3447; C08K 2003/2296; C08K 2201/006

(57) ABSTRACT

Provided is a sealing member that can suppress occurrence of cracks and the like during demolding in a die molding process and that has excellent resistance to copper contamination. The sealing member includes a crosslinked product of a rubber composition containing components (A) to (E), wherein the ethylene content of component (A) is 50 mass % or more, and the content of component (B) is 30 to 90 parts by mass, the content of component (D) is 0.5 to 10 parts by mass, and the content of component (E) is 3 to 10 parts by mass, with respect to 100 parts by mass of component (A). (A) At least one of an ethylene-propylene-diene rubber and an ethylene-butene-diene rubber (B) Silica (C) Organic peroxide (D) Benzimidazole-based antioxidant (E) Zinc oxide

### CROSS-REFERENCE TO RELATED APPLICATION

The present application is a continuation of PCT/JP2025/007773, filed on Mar. 4, 2025, and is related to and claims priority from Japanese Patent Application No. 2024-053262 filed on Mar. 28, 2024. The entire contents of the aforementioned application are hereby incorporated by reference herein.

### TECHNICAL FIELD

The disclosure relates to a sealing member including a crosslinked product of a rubber composition.

### BACKGROUND ART

Various types of sealing members are used in various devices such as electronic devices to ensure the waterproof properties or the like. For example, wire sealing members that function to prevent the intrusion of water or the like are used in connector housings or the like used in automotive wire harnesses, etc. (see, for example, Patent Document 1 (Japanese Patent Application Laid-Open No. 05-258802)).

Such wire sealing members are each composed of a cylindrical body having a through hole for inserting wires, and multiple protrusions that protrude radially outward are formed to exhibit waterproof function. For example, like the wire sealing member shown in FIGURE, the wire sealing member has a substantially cylindrical small diameter portion 1 and a large diameter portion 2 which has multiple protrusions protruding radially outward and grooves. The wire sealing member ensures waterproof properties or the like with formation of multiple protrusions (such as 2a) and grooves (such as 2d).

Sealing members such as the aforementioned wire sealing members are often required to have complex and precise shapes, and there is a concern that cracks (fractures) or deformation may occur during demolding in the die molding process.

In addition, sealing members are used in a wide variety of products and are often used in contact with metal members, so deterioration due to redox reactions is a concern, and deterioration due to “copper contamination” caused by contact between sealing members and copper is particularly serious.

The disclosure provides a sealing member that is capable of suppressing occurrence of cracks and the like during demolding in a die molding process and further is capable of suppressing deterioration due to copper contamination.

The inventors of the disclosure conducted extensive research, and as a result, found that, in a sealing member including a crosslinked product of a rubber composition containing (A) at least one of ethylene-propylene-diene rubber and ethylene-butene-diene rubber, (B) silica, (C) organic peroxide, (D) benzimidazole-based antioxidant, and (E) zinc oxide, setting the ethylene content of component (A) within a specific range and setting the contents of other components with respect to component (A) within respective specific ranges can suppress occurrence of cracks and the like during demolding in the die molding process, and further found that deterioration due to copper contamination can also be suppressed.

### SUMMARY

The disclosure has the following [1] to [10] as its gist.

[1]

A sealing member, comprising a crosslinked product of a rubber composition containing components (A) to (E),
wherein component (A) has an ethylene content of 50 mass % or more, and a content of component (B) is 30 to 90 parts by mass, a content of component (D) is 0.5 to 10 parts by mass, and a content of component (E) is 3 to 10 parts by mass, with respect to 100 parts by mass of component (A),
(A) at least one of ethylene-propylene-diene rubber and ethylene-butene-diene rubber,
(B) silica,
(C) organic peroxide,
(D) benzimidazole-based antioxidant, and
(E) zinc oxide.
   [2]

The sealing member according to [1], wherein the ethylene content of component (A) is 60 mass % or more.

[3]

The sealing member according to [1] or [2], wherein the content of component (B) is 50 to 90 parts by mass with respect to 100 parts by mass of component (A).

[4]

The sealing member according to any one of [1] to [3], wherein component (B) has a BET specific surface area of 30 to 250 m²/g.

[5]

The sealing member according to any one of [1] to [4], wherein component (E) and component (D) have a mass ratio (E/D) of 0.5 to 10.

[6]

The sealing member according to any one of [1] to [5], further comprising erucic acid amide.

[7]

The sealing member according to [6], wherein the erucic acid amide is contained in a content of 1 to 15 parts by mass with respect to 100 parts by mass of component (A).

[8]

The sealing member according to any one of [1] to [7], wherein the ethylene-propylene-diene rubber (A) has a diene component that is 5-vinyl-2-norbornene.

[9]

The sealing member according to any one of [1] to [8], wherein the sealing member is a wire sealing member comprising a plurality of protrusions that protrude radially outward.

[10]

The sealing member according to any one of [1] to [9], comprising a zinc salt of 2-mercaptobenzimidazole as component (D), wherein the zinc salt of 2-mercaptobenzimidazole is contained in a content of 0.5 to 10 parts by mass with respect to 100 parts by mass of component (A), and the content of component (E) is 0 to 10 parts by mass.

According to the disclosure, it is possible to provide a sealing member excellent in moldability and copper contamination resistance. Specifically, the sealing member of the disclosure is capable of suppressing occurrence of cracks and the like during demolding in the die molding process and further is capable of suppressing deterioration due to copper contamination.

### BRIEF DESCRIPTION OF THE DRAWINGS

FIG. 1 is a diagram showing an example of a wire sealing member.

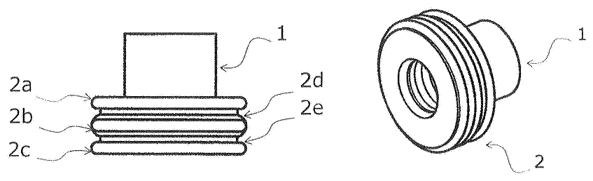

### DESCRIPTION OF THE EMBODIMENTS

Next, embodiments of the disclosure will be described in detail. Nevertheless, the disclosure is not limited to these embodiments.

It is noted that in this specification, “main component” means the most abundant component in the target object, and is usually 30 mass % or more in the target object, preferably 50 mass % or more, more preferably 60 mass % or more, and may be, for example, 70 to 100 mass %, 80 to 100 mass %, 90 to 100 mass %, 95 to 100 mass %, etc.

The sealing member according to one embodiment of the disclosure (hereinafter may be referred to as “the present sealing member”) is a sealing member including a crosslinked product of a rubber composition (hereinafter may be referred to as “the present rubber composition”) containing components (A) to (E), wherein the ethylene content of component (A) is 50 mass % or more, and the content of component (B) is 30 to 90 parts by mass, the content of component (D) is 0.5 to 10 parts by mass, and the content of component (E) is 3 to 10 parts by mass, with respect to 100 parts by mass of component (A).
(A) At least one of ethylene-propylene-diene rubber (EPDM) and ethylene-butene-diene rubber (EBT).
(B) Silica.
(C) Organic peroxide.
(D) Benzimidazole-based antioxidant.
(E) Zinc oxide.

The inventors of the disclosure initiated research and development of a rubber composition that includes EPDM and EBT (hereinafter may be referred to as “EPDM and the like”) among various rubber components as a rubber material capable of ensuring the performance of sealing members, and includes a white reinforcing material as a reinforcing material from the viewpoint of enhancing design properties (coloring flexibility).

In the process of such research and development, it was found that in formulation systems that include EPDM and the like and a white reinforcing material, the interaction between polymer chains of EPDM and the like (hydrophobic) and particles such as silica (hydrophilic) is weak, resulting in low modulus at high temperature (for example, die molding temperature such as 170° C.) and making it difficult to suppress cracks and deformation during demolding in the die molding process. In the process of such research and development, it was also found that there are issues with copper contamination resistance for reasons such as white reinforcing materials not functioning as radical scavengers.

The inventors conducted further research in view of the above circumstances, and as a result, found that it is possible to achieve both moldability and copper contamination resistance at a high level by blending components (A) to (E) in specific proportions. The present sealing member is capable of suppressing cracks and deformation during demolding in the die molding process, and has excellent copper contamination resistance.

The reason why the present sealing member exhibits the excellent effects described above is not necessarily clear, but according to the insight of the inventors, the interaction between EPDM and the like having an ethylene content of 50 mass % or more and a specific amount of silica enhances the modulus at high temperature, and furthermore, the interaction between the benzimidazole-based antioxidant and zinc oxide suppresses crosslinking inhibition, thereby enabling the modulus at high temperature to be maintained at a high level, which is presumed to contribute to improving the effect of suppressing cracks and the like during demolding. On the other hand, it is presumed that the interaction between the benzimidazole-based antioxidant and zinc oxide promotes the inactivation effect on copper surfaces, resulting in particularly excellent copper contamination resistance.

Further, since the present sealing member uses silica as a white reinforcing material, it becomes possible to enhance the design properties (coloring flexibility) of the sealing member. Therefore, the present sealing member is also highly useful in that it is easy to color the present sealing member with a desired color according to various applications and needs.

Each component constituting the present rubber composition will be described below, but the disclosure is not limited thereto.

The present rubber composition is suitable as a rubber composition for forming a sealing member, in which the ethylene content of component (A) is 50 mass % or more, and the content of component (B) is 30 to 90 parts by mass, the content of component (D) is 0.5 to 10 parts by mass, and the content of component (E) is 3 to 10 parts by mass, with respect to 100 parts by mass of component (A), and is particularly useful as a rubber composition for forming a wire sealing member.
(A) At least one of ethylene-propylene-diene rubber (EPDM) and ethylene-butene-diene rubber (EBT).
(B) Silica.
(C) Organic peroxide.
(D) Benzimidazole-based antioxidant.
(E) Zinc oxide.

### <<(A) at Least One of Ethylene-Propylene-Diene Rubber and Ethylene-Butene-Diene Rubber>>

As component (A), at least one of ethylene-propylene-diene rubber (EPDM) and ethylene-butene-diene rubber (EBT) is used. EPDM is obtained by copolymerizing ethylene, propylene, and diene components, and EBT is obtained by copolymerizing ethylene, butene, and diene components. These are used alone or in combination of two or more types.

The ethylene content in component (A) is 50 mass % or more. In the case of the ethylene content being less than 50 mass %, there is a tendency for the modulus at high temperature to decrease and there is a tendency for cracks and the like to occur during demolding. It is noted that the ethylene content in component (A) can be appropriately set within the above range, and for example, 55 mass % or more, 58 mass % or more, 60 mass % or more, etc. are preferable. The upper limit of the ethylene content is not particularly limited, but is, for example, 72 mass % or less.

The propylene content in component (A) is not particularly limited, but is, for example, 30 to 50 mass %, preferably 30 to 45 mass %, and more preferably 35 to 45 mass %. Further, the butene content in component (A) is not particularly limited, but is, for example, 30 to 50 mass %, preferably 30 to 45 mass %, and more preferably 35 to 45 mass %.

As the diene component which is the third component in the above component (A), for example, diene-based monomers having 5 to 20 carbon atoms are preferable, and specifically, examples include 1,4-pentadiene, 1,4-hexadiene, 1,5-hexadiene, 2,5-dimethyl-1,5-hexadiene, 1,4-octadiene, 1,4-cyclohexadiene, cyclooctadiene, dicyclopentadiene (DCP), 5-ethylidene-2-norbornene (ENB), 5-vinyl-2-norbornene (VNB), 5-butylidene-2-norbornene, 2-methallyl-5-norbornene, 2-isopropenyl-5-norbornene, and the like.

Among the above diene-based monomers, 5-vinyl-2-norbornene (VNB) is preferable from the viewpoint of improving the modulus at high temperature and the viewpoint of suppressing cracks and the like during demolding, and as component (A), ethylene-propylene-VNB rubber is particularly preferable.

The diene content in component (A) is not particularly limited, but is, for example, 1 to 15 mass %, preferably 3 to 15 mass %, and more preferably 5 to 12 mass %. The diene content can be appropriately set within the above range, and may be, for example, 1 to 10 mass %, 1 to 6 mass %, 1 to 3 mass %, and the like.

For example, in the case of the above diene component being 5-ethylidene-2-norbornene (ENB), the content of ENB is preferably 1 to 15 mass %, 3 to 15 mass %, 3.5 to 12 mass %, 4 to 10 mass %, 5 to 10 mass %, and the like. Further, in the case of the above diene component being 5-vinyl-2-norbornene (VNB), the content thereof is preferably 1 to 5 mass %, 1 to 4 mass %, 1 to 3 mass %, and the like.

Component (A) constitutes the main component of the rubber component contained in the present rubber composition, and the content thereof is usually preferably 30 mass % or more with respect to the total amount of the rubber composition (100 mass %). Further, the content of component (A) may be 30 to 70 mass %, 32 to 65 mass %, 34 to 55 mass %, and the like with respect to the total amount of the rubber composition (100 mass %).

### <<(B) Silica>>

In the present sealing member, (B) silica is particularly used as a white reinforcing material. Examples of silica include wet silica, dry silica, and the like. These are used alone or in combination of two or more types.

Component (B) is not particularly limited, but wet silica is preferable. Examples of wet silica include wet silica obtained by neutralization reaction between sodium silicate and mineral acid (precipitation method silica synthesized and aggregated under alkaline conditions, gel method silica particles synthesized and aggregated under acidic conditions); colloidal silica obtained by making acidic silicic acid alkaline and polymerizing; and sol-gel silica obtained by hydrolysis of organic silane compounds (for example, alkoxysilane). Among these, precipitation method silica is particularly preferable from the viewpoint of improving the modulus at high temperature and the viewpoint of suppressing cracks and the like during demolding.

The content of component (B) is 30 to 90 parts by mass, and preferably 50 to 90 parts by mass, with respect to 100 parts by mass of component (A). In the case of the above content being outside the above range, there is a tendency for the modulus at high temperature to decrease and there is a tendency for cracks and the like to occur during demolding. It is noted that the content of component (B) can be appropriately set within the above range, and may be, for example, 40 to 80 parts by mass, 45 to 70 parts by mass, 50 to 65 parts by mass, and the like.

The pH value of component (B) is not particularly limited, but is preferably pH 5.5 to 9.0, more preferably pH 5.5 to 7.5, and even more preferably pH 6.0 to 7.0, from the viewpoint of suppressing modulus decrease due to vulcanization inhibition.

The above pH value is determined according to ISO787-9, and specifically, can be determined by preparing a 10% mass fraction suspension of silica to be tested using water in a glass container, capping the container and shaking vigorously for 1 minute, leaving the container still for 5 minutes, then removing the cap, and measuring the pH of the suspension in units of 0.1.

The BET specific surface area of component (B) is not particularly limited, but is, for example, preferably 30 to 250 m²/g, more preferably 30 to 210 m²/g, and even more preferably 30 to 170 m²/g, from the viewpoint of improving the modulus at high temperature and the viewpoint of suppressing cracks and the like during demolding. The BET specific surface area of component (B) can be appropriately set within the above range and is not particularly limited, but may be, for example, 30 to 150 m²/g, 30 to 100 m²/g, 30 to 80 m²/g, etc.

It is noted that the BET specific surface area of silica can be determined, for example, by degassing a sample at 200° C. for 15 minutes, and then using a mixed gas (N₂: 70%, He: 30%) as adsorption gas with a BET specific surface area measuring device (manufactured by Microdata, 4232-II).

### <<(C) Organic Peroxide>>

Organic peroxide functions as a crosslinking agent in the present sealing member. The organic peroxide is not particularly limited, but examples include peroxyketal, peroxyester, dialkyl peroxide, ketone peroxide, diacyl peroxide, peroxydicarbonate, and the like. These are used alone or in combination of two or more types.

Examples of peroxyketal include n-butyl-4,4-di(t-butylperoxy) valerate, 2,2-di(t-butylperoxy) butane, 2,2-di(4,4-di(t-butylperoxy)cyclohexyl)propane, 1,1-di(t-butylperoxy)cyclohexane, 1,1-di(t-hexylperoxy)cyclohexane, 1,1-di(t-hexylperoxy)-3,3,5-trimethylcyclohexane, 1,1-di(t-butylperoxy)-2-methylcyclohexane, and the like.

Examples of peroxyester include t-butyl peroxybenzoate, t-butyl peroxyacetate, t-hexyl peroxybenzoate, 2,5-dimethyl-2,5-di(benzoylperoxy) hexane, t-butyl peroxy-2-ethylhexyl monocarbonate, t-butyl peroxylaurate, t-butyl peroxyisopropyl monocarbonate, t-butyl peroxy-3,5,5-trimethylhexanoate, t-butyl peroxymaleic acid, t-hexyl peroxyisopropyl monocarbonate, and the like.

Examples of dialkyl peroxide include di(2-t-butylperoxypropyl)benzene, dicumyl peroxide, 2,5-dimethyl-2,5-di(t-butylperoxy) hexane, t-butylcumyl peroxide, di-t-hexyl peroxide, di-t-butyl peroxide, 2,5-dimethyl-2,5-di(t-butylperoxy) hexyne-3, and the like.

The content of component (C) is not particularly limited, but is preferably 1.5 to 14 parts by mass, and more preferably 2 to 13 parts by mass, with respect to 100 parts by mass of component (A). The content of component (C) can be appropriately set within the above range, and may be, for example, 3 to 11 parts by mass, 4 to 10 parts by mass, and the like.

It is noted that in the case of not using a raw material with 100% purity as component (C), the component is blended so that the proportion calculated in terms of the raw material falls within the above range.

### <<(D) Benzimidazole-Based Antioxidant>>

Examples of component (D) include 2-mercaptobenzimidazole (MBI), 2-mercapto-5-methylbenzimidazole, 2-mercapto-5-methoxybenzimidazole, 2-mercapto-5-carboxybenzimidazole, 2-mercapto-5-nitrobenzimidazole, 1,3-dihydro-1-phenyl-2H-benzimidazole-2-thione, and metal salts thereof (for example, 2-mercaptobenzimidazole zinc salt (ZnMBI)), and the like. These are used alone or in combination of two or more types.

The content of component (D) is 0.5 to 10 parts by mass with respect to 100 parts by mass of component (A). In the case of the content being outside the above range, there is a tendency for the modulus at high temperature to decrease, there is a tendency for cracks and the like to occur during demolding, or there is a tendency for copper contamination resistance to decrease. It is noted that the content of component (D) can be appropriately set within the above range, and may be, for example, 0.5 to 8 parts by mass, 1 to 7 parts by mass, 1.5 to 5 parts by mass, and the like.

### <<(E) Zinc Oxide>>

Examples of component (E) include zinc oxide type 1, zinc oxide type 2, zinc oxide type 3, fine zinc oxide, and the like. These are used alone or in combination of two or more types.

The content of component (E) is 3 to 10 parts by mass with respect to 100 parts by mass of component (A). In the case of the content being outside the above range, there is a tendency for the modulus at high temperature to decrease, there is a tendency for cracks and the like to occur during demolding, or there is a tendency for copper contamination resistance to decrease. It is noted that the content of component (E) can be appropriately set within the above range, and may be, for example, 3.5 to 9 parts by mass, 4 to 8 parts by mass, and the like.

The mass ratio of component (E) to component (D)((E) zinc oxide/(D) benzimidazole-based antioxidant) is preferably 0.5 to 10, more preferably 0.5 to 8, and even more preferably 0.5 to 6, from the viewpoint of remarkably achieving the effects of the disclosure.

### <<(F) Fatty Acid Amide>>

The present rubber composition may optionally include (F) fatty acid amide. Examples of component (F) include caproic acid amide, lauric acid amide, myristic acid amide, palmitic acid amide, stearic acid amide, oleic acid amide, erucic acid amide, methylene bis stearic acid amide, ethylene bis stearic acid amide, and the like. These are used alone or in combination of two or more types. Among these, erucic acid amide is preferable from the viewpoint of improving the modulus at high temperature and the viewpoint of suppressing cracks and the like during demolding.

The content of component (F) is not particularly limited, but is, for example, 0.5 to 30 parts by mass, and preferably 1 to 25 parts by mass, with respect to 100 parts by mass of component (A). Further, the content of component (F) may be 1 to 20 parts by mass, 2 to 15 parts by mass, 3 to 12 parts by mass, and the like.

### <<Other Components>>

The present rubber composition may optionally include additives other than the above components (A) to (F), such as antioxidants, processing aids, silane coupling agents, colorants, plasticizers, crosslinking aids, rubber components, and other optional materials as needed, within a range that does not impair the effects of the disclosure. These are used alone or in combination of two or more types.

### (Antioxidant)

Examples of antioxidants include diphenylamine-based antioxidants, phenylenediamine-based antioxidants, carbamate-based antioxidants, phenol-based antioxidants, phenylamine-based antioxidants, quinoline-based antioxidants, waxes, and the like. These are used alone or in combination of two or more types.

Examples of diphenylamine-based antioxidants include p-(p-toluenesulfonylamido)diphenylamine, 4,4′-bis(α,α-dimethylbenzyl)diphenylamine, octylated diphenylamine, styrenated diphenylamine, and the like.

Examples of phenylenediamine-based antioxidants include N-(1,3-dimethylbutyl)-N′-phenyl-p-phenylenediamine, N,N′-di-β-naphthyl-p-phenylenediamine, N,N′-diphenyl-p-phenylenediamine, N-isopropyl-N′-phenyl-p-phenylenediamine, N-phenyl-N′-(1,3-dimethylbutyl)-p-phenylenediamine, N-(3-methacryloyloxy-2-hydroxypropyl)-N′-phenyl-p-phenylenediamine, N-cyclohexyl-N′-phenyl-p-phenylenediamine, and the like.

The content of the antioxidant (but excluding component (D)) is not particularly limited, but is, for example, 0.1 to 4 parts by mass, preferably 0.2 to 3 parts by mass, and more preferably 0.3 to 2 parts by mass, with respect to 100 parts by mass of component (A).

### (Processing Aid)

Examples of processing aids include higher fatty acids such as stearic acid and oleic acid, higher fatty acid salts such as sodium stearate, higher fatty acid esters such as ethyl oleate, and the like. These are used alone or in combination of two or more types.

The content of the processing aid is not particularly limited, but is, for example, 0.5 to 10 parts by mass, preferably 0.8 to 8 parts by mass, and more preferably 1 to 5 parts by mass, with respect to 100 parts by mass of component (A).

### (Silane Coupling Agent)

Examples of silane coupling agents include mercapto-based silane coupling agents, sulfide-based silane coupling agents, amine-based silane coupling agents, epoxy-based silane coupling agents, vinyl-based silane coupling agents, and the like. These are used alone or in combination of two or more types.

Examples of mercapto-based silane coupling agents include 3-mercaptopropyltrimethoxysilane, 3-mercaptopropyltriethoxysilane, and the like.

Examples of sulfide-based silane coupling agents include bis-(3-(triethoxysilyl)-propyl)-disulfide, bis(3-triethoxysilylpropyl)trisulfide, bis-(3-(triethoxysilyl)-propyl)-tetrasulfide, bis(3-trimethoxysilylpropyl) disulfide, bis(2-triethoxysilylethyl)tetrasulfide, bis(2-trimethoxysilylethyl)tetrasulfide, bis(3-triethoxysilylpropyl) disulfide, 3-trimethoxysilylpropyl-N,N-dimethylthiocarbamoyltetrasulfide, 3-triethoxysilylpropyl-N,N-dimethylthiocarbamoyltetrasulfide, 2-triethoxysilylethyl-N,N-dimethylthiocarbamoyltetrasulfide, 2-trimethoxysilylethyl-N,N-dimethylthiocarbamoyltetrasulfide, 3-trimethoxysilylpropylbenzothiazolyltetrasulfide, 3-triethoxysilylpropylbenzothiazoletetrasulfide, 3-triethoxysilylpropylmethacrylate monosulfide, 3-trimethoxysilylpropylmethacrylate monosulfide, and the like.

Examples of amine-based silane coupling agents include 3-aminopropyltriethoxysilane, 3-aminopropyltrimethoxysilane, N-(2-aminoethyl)-3-aminopropyltrimethoxysilane, N-(2-aminoethyl)-3-aminopropylmethyldimethoxysilane, 3-(N-phenyl)aminopropyltrimethoxysilane, and the like.

Examples of epoxy-based silane coupling agents include 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, 3-glycidoxypropylmethyldimethoxysilane, and the like.

Examples of vinyl-based silane coupling agents include vinyltriethoxysilane, vinyltrimethoxysilane, vinyltris(β-methoxyethoxy) silane, vinyldimethylchlorosilane, vinyltrichlorosilane, vinyltriisopropoxysilane, vinyltris(2-methoxyethoxy) silane, and the like.

The content of the silane coupling agent is not particularly limited, but is, for example, 0.1 to 10 parts by mass, preferably 0.5 to 8 parts by mass, and more preferably 1 to 6 parts by mass, with respect to 100 parts by mass of component (A).

### (Plasticizer)

Examples of plasticizers include adipic acid derivative-based, azelaic acid derivative-based, sebacic acid derivative-based, paraffinic process oil, naphthenic process oil, and the like. These are used alone or in combination of two or more types.

The content of the plasticizer is not particularly limited, but is, for example, 10 to 60 parts by mass, preferably 15 to 55 parts by mass, and more preferably 20 to 45 parts by mass, with respect to 100 parts by mass of (A).

### (Colorant)

Examples of colorants include inorganic pigments and organic pigments. Examples of inorganic pigments include titanium dioxide, zinc white, zinc powder, zinc lead, aluminum pigment, lead monoxide, micaceous iron oxide pigment, red lead, lead white, chrome yellow, ocher, kaolin, clay, ultramarine, prussian blue, iron oxide, lead cyanamide, heavy calcium carbonate, zinc chromate, talc, iron yellow, chalk, and the like. Examples of organic pigments include azo-based pigments such as soluble azo red, monoazo yellow, monoazo red, disazo yellow, and disazo orange, and phthalocyanine-based pigments such as copper phthalocyanine blue, copper phthalocyanine green, and cobalt phthalocyanine blue. These are used alone or in combination of two or more types.

The content of the colorant is not particularly limited, but is, for example, 1 to 20 parts by mass, 2 to 18 parts by mass, 3 to 12 parts by mass, and the like, with respect to 100 parts by mass of (A).

### (Crosslinking Aid)

Examples of crosslinking aids include maleimide compounds, triallyl cyanurate (TAC), triallyl isocyanurate (TAIC), ethylene glycol dimethacrylate (EG), amylphenol disulfide polymer, trimethylolpropane trimethacrylate (TMPT), and the like. The content of the crosslinking aid is not particularly limited, but is, for example, about 0.1 to 5 parts by mass with respect to 100 parts by mass of component (A).

It is noted that the present rubber composition may include carbon black as a reinforcing material. Examples of carbon black include carbon black of various grades such as SAF grade, ISAF grade, HAF grade, MAF grade, FEF grade, GPF grade, SRF grade, FT grade, and MT grade.

The content of carbon black is not particularly limited, but is, for example, 5 to 50 parts by mass, 5 to 30 parts by mass, and the like, with respect to 100 parts by mass of component (A).

It is noted that polymer chains (hydrophobic) such as EPDM and carbon black particles (hydrophobic) have strong interaction, and although moldability of the sealing member can be improved by enhanced reinforcement, design properties (coloring flexibility) are insufficient, which makes it difficult to color with a desired color.

From the viewpoint of enhancing design properties (coloring flexibility), the content of carbon black is preferably 30 parts by mass or less, more preferably 15 parts by mass or less, and even more preferably 5 parts by mass or less, with respect to 100 parts by mass of component (A). It may be preferable to include substantially no carbon black, and it may also be preferable to include no carbon black (0 parts by mass).

### Other Embodiments

As another embodiment of the sealing member of the disclosure, an embodiment includes a zinc salt of 2-mercaptobenzimidazole as component (D) contained in the rubber composition, with the content of the zinc salt of 2-mercaptobenzimidazole being 0.5 to 10 parts by mass with respect to 100 parts by mass of component (A), and the content of (E) zinc oxide being 0 to 10 parts by mass with respect to 100 parts by mass of component (A).

That is, in the embodiment described in detail above, the interaction between the benzimidazole-based antioxidant and zinc oxide generates, for example, a zinc salt of 2-mercaptobenzimidazole or the like, thereby enhancing the modulus at high temperature and copper contamination resistance. However, as in other embodiments, it is also possible to blend the zinc salt of 2-mercaptobenzimidazole alone. Such other embodiments also exhibit similar effects, and can enhance the modulus at high temperature and copper contamination resistance.

It is noted that other embodiments do not exclude blending zinc oxide, and the zinc salt of 2-mercaptobenzimidazole and zinc oxide may be used in combination.

The content of the above zinc salt of 2-mercaptobenzimidazole is, for example, preferably 0.5 to 10 parts by mass, and more preferably 0.5 to 8 parts by mass, with respect to 100 parts by mass of component (A).

The content of the above (E) zinc oxide is, for example, preferably 0 to 10 parts by mass, and more preferably 3.5 to 8 parts by mass, with respect to 100 parts by mass of component (A).

From a similar viewpoint, another embodiment of the sealing member of the disclosure may be, for example, an embodiment of a sealing member including a crosslinked product of a rubber composition containing components (A) to (D), wherein the ethylene content of component (A) is 50 mass % or more, component (D) is a zinc salt of 2-mercaptobenzimidazole, and the content of component (B) is 30 to 90 parts by mass, and the content of the zinc salt of 2-mercaptobenzimidazole is 0.5 to 10 parts by mass, with respect to 100 parts by mass of component (A).
(A) At least one of ethylene-propylene-diene rubber and ethylene-butene-diene rubber.
(B) Silica.
(C) Organic peroxide.
(D) Benzimidazole-based antioxidant.

It is noted that commercial products of the zinc salt of 2-mercaptobenzimidazole include “Sanceler MZ” manufactured by Sanshin Chemical Industry Co., Ltd.

### (Preparation of the Present Rubber Composition, and Crosslinking Molding of the Present Sealing Member)

Preparation of the present rubber composition is not particularly limited, but is performed by kneading various materials using kneading machines such as single-screw extruders, twin-screw extruders, open rolls, Banbury mixers, and kneaders. Crosslinking molding of the present rubber composition is not particularly limited, but is performed by a crosslinking process at about 160 to 180° C. for about 8 to 15 minutes.

### (Usefulness of the Present Sealing Member)

The present sealing member has high modulus at high temperature, is capable of suppressing occurrence of cracks and the like during demolding in the die molding process, and further excels in copper contamination resistance. Therefore, the present sealing member is very technically useful.

The modulus at high temperature is not limited to the following, but as M100 (100% modulus) based on the measurement method (conditions of 170° C.) described in the examples below, for example, 1.5 MPa or more is preferable, and 1.7 MPa or more is more preferable.

### (Applications of the Present Rubber Composition and the Present Sealing Member)

The present rubber composition is suitable as a rubber composition for forming sealing members, and is particularly useful as a rubber composition for forming wire sealing members.

The present sealing member can be used as various sealing members such as O-rings and gaskets, but is particularly suitable as a wire sealing member. The wire sealing member is, for example, a member having a through hole for inserting a wire (electric wire), as shown in FIGURE, and includes a substantially cylindrical small diameter portion 1 and a large diameter portion 2 that has multiple protrusions protruding radially outward and grooves. Such a wire sealing member effectively prevents intrusion of water, dust, oil, or the like from the outside with multiple protrusions (2a, 2b, 2c) and grooves (2d, 2e) formed in the large diameter portion 2. The present sealing member exhibits particularly excellent performance in molded products that require complex and precise shapes, such as wire sealing members and automotive sealing members around automobile engines and electronic components.

### EXAMPLES

Next, examples will be described together with comparative examples. Nevertheless, the disclosure is not limited to these examples. It is noted that in Table 1, “Et amount” means the ethylene content.

First, the materials shown below were prepared.

### <(A) EPDM, EBT (Ethylene Content 50 Mass % or More)>

EPDM (a1): ethylene content 50 mass %, ENB-EPT 3090EM, manufactured by Mitsui Chemicals.
EPDM (a2): ethylene content 60 mass %, ENB-EPT 3091, manufactured by Mitsui Chemicals.
EBT (a3): ethylene content 50 mass %, ENB-EBT K-9330M, manufactured by Mitsui Chemicals.
EPDM (a4): ethylene content 60 mass %, VNB-EPT PX-006M, manufactured by Mitsui Chemicals.
   <(A′) EPDM, EBT (Ethylene Content Less than 50 Mass %)>
EPDM (a′): ethylene content 45 mass %, EPT 4045M, manufactured by Mitsui Chemicals.

### <(B) Silica>

Silica (b1): wet silica, BET specific surface area 48 m²/g, pH 6.8, Nipsil EL, manufactured by Tosoh Silica Corporation.
   <(B′) White Reinforcing Material Other than Silica>
Talc (b′): Fuji Talc RS613, manufactured by Fuji Talc Industrial Co., Ltd.

### <(C) Organic Peroxide>

Organic peroxide (c1): Percumyl D-40, manufactured by NOF Corporation.

### <(D) Benzimidazole-Based Antioxidant>

2-mercaptobenzimidazole (d1): B0055, manufactured by Tokyo Chemical Industry Co., Ltd.

### <(E) Zinc Oxide>

Zinc oxide type 2 (e1): manufactured by Mitsui Mining & Smelting Co., Ltd.

### <(F) Fatty Acid Amide>

Erucic acid amide (f1): D1008, manufactured by Tokyo Chemical Industry Co., Ltd.

### <Other Components>

Antioxidant: diphenylamine-based antioxidant, B1970, manufactured by Tokyo Chemical Industry Co., Ltd.
Processing aid: stearic acid, Bead Stearic Acid Sakura, manufactured by NOF Corporation.
Processing aid: paraffinic oil, Diana Process PW-380, manufactured by Idemitsu Kosan Co., Ltd.
Colorant: titanium dioxide, T4017, manufactured by Tokyo Chemical Industry Co., Ltd.
Silane coupling agent: V0042, manufactured by Tokyo Chemical Industry Co., Ltd.

### Examples 1 to 13, Comparative Examples 1 to 8

Components (A) to (F) and others were blended at the ratios shown in Table 1 below, and components described in the above “Other components” were blended at ratios of 0.5 parts by mass of diphenylamine-based antioxidant, 2 parts by mass of stearic acid, 10 parts by mass of titanium dioxide, 2 parts by mass of silane coupling agent, and 40 parts by mass of paraffinic oil, with respect to 100 parts by mass of component (A).

Among the above components, components other than component (C) were blended at the above ratios and kneaded with a 1.7 L Banbury mixer, and then component (C) was kneaded with an 8-inch roll to prepare an uncrosslinked rubber composition. The following evaluations were performed using the obtained rubber composition. The results are shown together in Table 1 below.

### <<High Temperature Modulus Test: 170° C., M100>>

Using the uncrosslinked rubber composition, a rubber sheet with a thickness of 2 mm was prepared with a 6-inch mixing roll, and this was subjected to hot pressing at 170° C. for 10 minutes to obtain a crosslinked product of the rubber sheet. JIS No. 5 dumbbells were punched out from the rubber sheet to prepare test specimens. The test specimens were left still for 10 minutes in a 170° C. atmosphere in accordance with JIS K 6251, and then a tensile test was performed to measure modulus 100 (M100) [MPa].

<<Moldability Test: Whether there are Cracks During Demolding>>

The uncrosslinked rubber composition was press-filled into a chamber in a die including an upper mold and a lower mold and crosslinked under conditions of 170° C. for 10 minutes, and a sealing member having the shape shown in FIGURE was molded. Thereafter, the upper mold was removed, the upper portion of the sealing member (see the small diameter portion 1 in FIGURE) was gripped with a jig and demolded from the lower mold, and whether there were cracks in the sealing member was evaluated. Cracks in the sealing member were visually confirmed, with cases having no cracks rated as “∘ (good)” and cases having cracks rated as “x (poor)”.

<<Copper Contamination Resistance Test: Whether there is Copper Contamination>>

Using the uncrosslinked rubber composition, a rubber sheet with a thickness of 2 mm was prepared with a 6-inch mixing roll, and this was subjected to hot pressing at 170° C. for 10 minutes to obtain a sheet-shaped test specimen (crosslinked product) (50 mm×10 mm×2 mm). The test specimen and a copper plate (50 mm×10 mm×0.2 mm) were installed in a compression jig, and with the test specimen and the copper plate in contact, the test specimen was compressed by 25% and aged at 160° C. for 120 hours, after which whether the test specimen blackened was evaluated. Blackening of the test specimen was visually confirmed, with cases having no copper contamination (blackening) rated as “∘ (good)” and cases having copper contamination (blackening) rated as “x (poor)”.

### [Table 1]

(parts by mass)

| | | Example | | | | | | | | | | |
|---|---|---|---|---|---|---|---|---|---|---|---|---|
| | | 1 | 2 | 3 | 4 | 5 | 6 | 7 | 8 | 9 | 10 | 11 |
| A | EP [symbol] M (e1) | 100 | — | — | — | 100 | 100 | 100 | 100 | 100 | 100 | 100 |
| | ( [symbol] ) | | | | | | | | | | | |
| | EP [symbol] M (e2) | — | 100 | — | — | — | — | — | — | — | — | — |
| | ( [symbol] ) | | | | | | | | | | | |
| | [symbol] (e3) | — | — | 100 | — | — | — | — | — | — | — | — |
| | ( [symbol] ) | | | | | | | | | | | |
| | EP [symbol] M (e4) | — | — | — | 11 [symbol] | — | — | — | — | — | — | — |
| | ( [symbol] ) | | | | | | | | | | | |
| | EP [symbol] M [symbol] | — | — | — | — | — | — | — | — | — | — | — |
| | ( [symbol] ) | | | | | | | | | | | |
| B | [symbol] ( [symbol] ) | [symbol] | [symbol] | [symbol] | [symbol] | [symbol] | [symbol] | [symbol] | [symbol] | [symbol] | [symbol] | [symbol] |
| | [symbol] ( [symbol] ) | — | — | — | — | — | — | — | — | — | — | — |
| C | Organic [symbol] | [symbol] .75 | [symbol] .75 | [symbol] .75 | [symbol] .75 | [symbol] .75 | [symbol] .75 | [symbol] .75 | [symbol] .75 | [symbol] .75 | [symbol] .75 | [symbol] .75 |
| D | [symbol] -based [symbol] (d1) | [symbol] | [symbol] | [symbol] | [symbol] | [symbol] | [symbol] | 0. [symbol] | 10 | [symbol] | [symbol] | [symbol] |
| E | Zinc oxide ( [symbol] ) | [symbol] | [symbol] | [symbol] | [symbol] | [symbol] | [symbol] | [symbol] | [symbol] | [symbol] | 10 | [symbol] |
| F | [symbol] ( [symbol] ) | [symbol] | [symbol] | [symbol] | [symbol] | [symbol] | [symbol] | [symbol] | [symbol] | [symbol] | [symbol] | [symbol] |
| | [symbol] | [symbol] | [symbol] | [symbol] | [symbol] | [symbol] | [symbol] | 10 | [symbol] | [symbol] | [symbol] | [symbol] |
| Evaluation | [symbol] at high temperature | 2.0 | 2.1 | 1.9 | [symbol] | 1.5 | [symbol] | 1. [symbol] | 1. [symbol] | 1.8 | 2 | 1.8 |
| | [symbol] | | | | | | | | | | | |
| | [symbol] | ◯ | ◯ | ◯ | ◯ | ◯ | ◯ | ◯ | ◯ | ◯ | ◯ | ◯ |
| | ◯ No | | | | | | | | | | | |
| | X Yes | | | | | | | | | | | |
| | Copper contamination? | ◯ | ◯ | ◯ | ◯ | ◯ | ◯ | ◯ | ◯ | ◯ | ◯ | ◯ |
| | ◯ No | | | | | | | | | | | |
| | X Yes | | | | | | | | | | | |

(parts by mass)

| | | Example | | Comparative Example | | | | | | | |
|---|---|---|---|---|---|---|---|---|---|---|---|
| | | 12 | 13 | 1 | 2 | 3 | 4 | 5 | 6 | 7 | 8 |
| A | EP [symbol] M (e1) | — | — | — | 100 | 100 | 100 | 100 | 100 | 100 | 100 |
| | ( [symbol] ) | | | | | | | | | | |
| | EP [symbol] M (e2) | — | — | — | — | — | — | — | — | — | — |
| | ( [symbol] ) | | | | | | | | | | |
| | [symbol] (e3) | — | — | — | — | — | — | — | — | — | — |
| | ( [symbol] ) | | | | | | | | | | |
| | EP [symbol] M (e4) | 11 [symbol] | 11 [symbol] | — | — | — | — | — | — | — | — |
| | ( [symbol] ) | | | | | | | | | | |
| | EP [symbol] M [symbol] | — | — | 100 | — | — | — | — | — | — | — |
| | ( [symbol] ) | | | | | | | | | | |
| B | [symbol] ( [symbol] ) | [symbol] | [symbol] | [symbol] | [symbol] | [symbol] | — | [symbol] | [symbol] | [symbol] | [symbol] |
| | [symbol] ( [symbol] ) | — | — | — | — | — | [symbol] | — | — | — | — |
| C | Organic [symbol] | [symbol] .75 | [symbol] .75 | [symbol] .75 | [symbol] .75 | [symbol] .75 | [symbol] .75 | [symbol] .75 | [symbol] .75 | [symbol] .75 | [symbol] .75 |
| D | [symbol] -based [symbol] (d1) | [symbol] | [symbol] | [symbol] | [symbol] | [symbol] | [symbol] | [symbol] | [symbol] | [symbol] | [symbol] |
| E | Zinc oxide ( [symbol] ) | [symbol] | [symbol] | [symbol] | [symbol] | [symbol] | [symbol] | [symbol] | [symbol] | [symbol] | [symbol] |
| F | [symbol] ( [symbol] ) | 5 | 10 | — | — | — | — | — | — | — | — |
| | [symbol] | [symbol] | [symbol] | [symbol] | [symbol] | [symbol] | [symbol] | [symbol] | [symbol] | [symbol] | [symbol] |
| Evaluation | [symbol] at high temperature | 2.0 | 1.8 | 1. [symbol] | 1. [symbol] | 1. [symbol] | 1.2 | 1.8 | 1.4 | [symbol] | 1.4 |
| | [symbol] | | | | | | | | | | |
| | [symbol] | ◯ | ◯ | X | X | X | X | ◯ | [symbol] | ◯ | [symbol] |
| | ◯ No | | | | | | | | | | |
| | X Yes | | | | | | | | | | |
| | Copper contamination? | ◯ | ◯ | ◯ | ◯ | ◯ | ◯ | X | ◯ | [symbol] | ◯ |
| | ◯ No | | | | | | | | | | |
| | X Yes | | | | | | | | | | |

[symbol]

indicates data missing or illegible when filed

From the results in Table 1 above, it was confirmed that the sealing member of the disclosure according to the examples has high modulus at high temperature, no cracks during demolding in the die molding process, and also good copper contamination resistance.

In contrast, because Comparative Example 1 did not contain the component (A) of the disclosure (because the ethylene content was less than 50 mass %), the modulus at high temperature was low and cracks occurred during demolding in the die molding process. Further, in Comparative Examples 2 and 3, the content of component (B) was outside the specified range of the disclosure (below the lower limit or above the upper limit), so the modulus at high temperature was low and cracks occurred during demolding in the die molding process.

Further, because Comparative Example 4 did not contain component (B) and contained talc, the modulus at high temperature was low and cracks occurred during demolding in the die molding process.

Further, in Comparative Examples 5 and 6, the content of component (D) was outside the specified range of the disclosure (below the lower limit or above the upper limit), so the modulus at high temperature was low and cracks occurred during demolding in the die molding process, or the copper contamination resistance was inferior.

Further, in Comparative Examples 7 and 8, the content of component (E) was outside the specified range of the disclosure (below the lower limit or above the upper limit), so the modulus at high temperature was low and cracks occurred during demolding in the die molding process, or the copper contamination resistance was inferior.

Although specific forms of the disclosure have been shown in the above examples, the above examples are merely illustrative and should not be interpreted in a limiting manner. Various modifications apparent to those skilled in the art are intended to be within the scope of the disclosure.

### INDUSTRIAL APPLICABILITY

The sealing member of the disclosure exhibits particularly excellent performance in molded products that require complex and precise shapes, such as automotive sealing members around automobile engines and electronic components.

1. A sealing member, comprising a crosslinked product of a rubber composition containing components (A) to (E),
wherein component (A) has an ethylene content of 50 mass % or more, and a content of component (B) is 30 to 90 parts by mass, a content of component (D) is 0.5 to 10 parts by mass, and a content of component (E) is 3 to 10 parts by mass, with respect to 100 parts by mass of component (A),
(A) at least one of ethylene-propylene-diene rubber and ethylene-butene-diene rubber,
(B) silica,
(C) organic peroxide,
(D) benzimidazole-based antioxidant, and
(E) zinc oxide.

2. The sealing member according to claim 1, wherein the ethylene content of component (A) is 60 mass % or more.

3. The sealing member according to claim 1, wherein the content of component (B) is 50 to 90 parts by mass with respect to 100 parts by mass of component (A).

4. The sealing member according to claim 1, wherein component (B) has a BET specific surface area of 30 to 250 m²/g.

5. The sealing member according to claim 1, wherein component (E) and component (D) have a mass ratio (E/D) of 0.5 to 10.

6. The sealing member according to claim 1, further comprising erucic acid amide.

7. The sealing member according to claim 6, wherein the erucic acid amide is contained in a content of 1 to 15 parts by mass with respect to 100 parts by mass of component (A).

8. The sealing member according to claim 1, wherein the ethylene-propylene-diene rubber (A) has a diene component that is 5-vinyl-2-norbornene.

9. The sealing member according to claim 1, wherein the sealing member is a wire sealing member comprising a plurality of protrusions that protrude radially outward.

10. The sealing member according to claim 1, comprising a zinc salt of 2-mercaptobenzimidazole as component (D),
wherein the zinc salt of 2-mercaptobenzimidazole is contained in a content of 0.5 to 10 parts by mass with respect to 100 parts by mass of component (A), and the content of component (E) is 0 to 10 parts by mass.
